(19) United States
(12) Patent Application Publication
(10) Pub. No.: US 2023/0232803 A1
(43) Pub. Date: Jul. 27, 2023

(54) Lead-Free Weedless Bottom Bouncer Device

(71) Applicants: Kenneth Avery, Caro, MI (US); Karen Avery, Caro, MI (US)

(72) Inventors: Kenneth Avery, Caro, MI (US); Karen Avery, Caro, MI (US)

(21) Appl. No.: 17/889,784

(22) Filed: Aug. 17, 2022

Related U.S. Application Data
(60) Provisional application No. 63/301,704, filed on Jan. 21, 2022.

(51) Int. Cl. A01K 91/06; A01K 85/00

(52) U.S. Cl. CPC A01K 91/065; A01K 85/00

(57) ABSTRACT

The present invention relates to a novel bottom bouncer device. The device is designed to provide fishermen with lead-free bait at an elevated level above the bottom surface. Specifically, the bottom bouncer device is configured for a fishing rod and is both lead-free and weedless. The device comprises a round, brass rod with a split ring at the top and a snap swivel attached to the split ring. Further, the bottom nine inches of the rod may be turned down in a lathe to produce differing weights for the bottom bouncer device.

### CROSS-REFERENCE TO RELATED APPLICATION

The present application claims priority to, and the benefit of, U.S. Provisional Application No. 63/301,704, which was filed on Jan. 21^{st}, 2022 and is incorporated herein by reference in its entirety.

### FIELD OF THE INVENTION

The present invention relates generally to the field of bottom bouncer devices. More specifically, the present invention relates to a bottom bouncer device for a fishing rod that provides users with a lead-free bait at an elevated level above the bottom surface. Specifically, the device comprises a brass rod with a split ring and a snap swivel attached to the top. Accordingly, the present disclosure makes specific reference thereto. Nonetheless, it is to be appreciated that aspects of the present invention are also equally applicable to other like applications, devices and methods of manufacture.

### BACKGROUND

By way of background, fishing has been commonly known for many years. Further, many fishermen are constantly looking for a more effective device for bottom fishing and/or trolling for such bottom feeding fish as walleye. As is well known, bottom feeding fish feed near the bottom of a body of water where rocks, sunken logs, weeds, and other snags exist. Such obstacles can cause fouling of the jig or line, thus leading to a loss of one or both. Thus, there is great incentive to create a bottom fishing device which is easy to manufacture and use than prior art devices, while at the same time minimizing the possibility that such device will foul when bottom fishing or trolling near the bottom of a body of water.

Further, current bottom bouncers are typically positioned low to the bottom, which loads the bait with weeds and prevents fish from biting the bait. Additionally, most bottom bouncers currently in use contain lead, which adds to lead pollution in the water. Finally, current bottom bouncers have more water drag, which puts more strain on a users' fishing equipment. All of these issues, cause the ineffectiveness of current bottom bouncers.

Therefore, a novel bottom bouncer device is needed that can provide fishermen with lead-free bait at an elevated level above the bottom surface. The device would protect wildlife by keeping lead-type bouncers out of the water and allows the bait to be above weed beds. Further, the device would reduce lead pollution compared to current bottom bouncer devices.

Therefore, there exists a long-felt need in the art for a bottom bouncer device that provides fishermen with lead-free bait at an elevated level above the bottom surface. There is also a long-felt need in the art for a bottom bouncer device that protects wildlife by keeping lead-type bouncers out of the water. Further, there is a long-felt need in the art for a bottom bouncer device that allows the bait to be above weed beds. Moreover, there is a long-felt need in the art for a device that reduces lead pollution compared to current bottom bouncer devices in use. Further, there is a long-felt need in the art for a bottom bouncer device that features a weedless design to allow more fishing time for users. Finally, there is a long-felt need in the art for a bottom bouncer device that improves the overall health and fitness of users capable of light exercise.

The subject matter disclosed and claimed herein, in one embodiment thereof, comprises a bottom bouncer device. The device is designed to provide fishermen with lead-free bait at an elevated level above the bottom surface. Specifically, the bottom bouncer device is configured for a fishing rod and is both lead-free and weedless. The device comprises a round, brass rod with a split ring at the top and a snap swivel attached to the split ring. Further, the bottom nine inches of the rod may be turned down in a lathe to produce differing weights for the bottom bouncer device.

In this manner, the bottom bouncer device of the present invention accomplishes all of the forgoing objectives and provides users with a device that is both lead-free and weedless. Further, the device can be produced in differing weights. The device also allows the bait to be above weed beds and reduces lead pollution.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a bottom bouncer device. The device is designed to provide fishermen with lead-free bait at an elevated level above the bottom surface. Specifically, the bottom bouncer device is configured for a fishing rod and is both lead-free and weedless. The device comprises a round, brass rod, but can be made of any other suitable material as is known in the art, such as metallic material in the form of a length of a steel rod or wire selected from conventional stock materials, rust resistant spring steel, carbon fiber, polymer, etc. The round rod typically comprises a diameter of from about 0.035 to about 0.190 inches. Further, the round rod is generally cylindrically shaped, but could also be hexagonally shaped, circular shaped, rectangular shaped, square shaped, or triangular shaped, etc., or any other suitable shape as is known in the art.

In one embodiment the bottom bouncer device comprises a flexible line, a float, and at least one weight. The flexible line is fabricated from wire, cable or any other suitable material as is known in the art. A loop is then formed on one end of the flexible line for attachment of a swivel connection, such as a snap swivel, or other suitable swivel connection as is known in the art. The snap swivel is provided to facilitate attachment of a line or leader. However, it is also within the scope of the invention to omit the snap swivel entirely, or to substitute the snap swivel with a lure or other device, without departing from the scope of the invention.

Typically, a leader line with a hook, or a fishing line with a hook are then connected to the flexible line and/or the snap swivel, or any other suitable line with a hook can be connected to the flexible line and/or the snap swivel, as is known in the art. A fishing line from a fishing rod and reel (not shown) is also attached to the snap swivel and/or the flexible line. Further, the snap swivel has a first eyelet at a first upper end to which the leader line and fishing line are connected and to which the loop, formed on the one end of the flexible line, is attached. Additionally, the float preferably includes a lengthwise through hole for receiving the flexible line. Generally, the float is fabricated from any suitable buoyant material. The float is preferably retained on one end of the flexible line by securing the float thereto. Typically, the float is secured to the flexible line via tying, spring hook, water resistant adhesive, etc., or any other suitable method as is known in the art.

In one embodiment, a split ring is secured to the top of the brass rod and a snap swivel is then attached to the split ring via the first eyelet of the snap swivel. Then, a leader line with a hook or a fishing line with a hook are then connected to the snap swivel and/or the flexible line.

In one embodiment, the weight includes a dense body. The dense body has a mass that is greater than the mass of water, such that the weight sinks to a bottom of water. A lengthwise through hole is formed through the dense body for receiving the flexible line. The removability of the weight allows different masses of weights to be quickly removed and secured to the flexible line. The weight may also be used on a fishing line cast from a fishing rod and reel without the benefit of the bottom bouncer. However, any suitable type of fastenable weight may be used, such as a split shot, etc. A split shot includes a split for retention of a flexible line. An outside perimeter of the split shot is squeezed and the flexible line is retained in the split shot.

In another embodiment, the bottom nine inches of the round rod may be turned down in a lathe to produce differing weights for the bottom bouncer device. A user can utilize a lathe to set the round rod to the desired weight. Keeping the round rod weight high can also help users avoid attaching any weights on the fishing line.

In another embodiment, the round rod is a single piece with a length of approximately 18.44 inches and a diameter of approximately 0.1875 inches. In yet another embodiment, the round rod is comprised of two rod components press fit together to form a single rod. In this embodiment, the first rod component would have a diameter of approximately 0.1875 inches and the second rod component would have a diameter of approximately 0.1563 inches, such that the second rod component will fit inside the first rod component. The total length of the two rod components secured together would be approximately 17.8516 inches. Further, the two rod components can be secured together via any suitable securing means, such as press fit, screwed, etc., depending on the needs and/or wants of a user.

In yet another embodiment, a method of providing fishermen with lead-free bait at an elevated level above the bottom surface is described. The method includes the steps of providing fishermen with a bottom bouncer device, wherein the device comprises a round rod with a split ring at the top and a snap swivel attached to the split ring. The method also comprises utilizing the device to position the bait at an elevated level above the bottom structure. Further, the method comprises reducing lead pollution by utilizing the lead-free bottom bouncer device. Finally, fishing with the bottom bouncer device without having the bait in the weed beds provides more fishing time.

In yet another embodiment of the present invention, a bottom bouncer device is disclosed to provide fishermen with lead-free bait at an elevated level above the bottom surface. The device comprises a round, brass rod with a split ring at the top and a snap swivel attached to the split ring. Further, the bottom nine inches of the rod may be turned down in a lathe to produce differing weights for the bottom bouncer device. Thus, the device allows the bait to be above weed beds and reduces lead pollution.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the bottom bouncer device of the present invention in accordance with the disclosed architecture;

FIG. 2 illustrates a perspective view of another embodiment of the bottom bouncer device of the present invention wherein the fishing line is extended in accordance with the disclosed architecture;

FIG. 3 illustrates a side perspective view showing the brass rod of the bottom bouncer device of the present invention in accordance with the disclosed architecture;

FIG. 4 illustrates a side perspective view showing an elongated brass rod of the bottom bouncer device of the present invention with the split ring and snap swivel attached in accordance with the disclosed architecture;

FIG. 5 illustrates a side perspective view of the bottom bouncer device comprised of one rod press fit inside the other rod with the split ring and snap swivel attached in accordance with the disclosed architecture; and

FIG. 6 illustrates a flowchart showing the method of providing fishermen with lead-free bait at an elevated level above the bottom surface in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a bottom bouncer device that provides fishermen with lead-free bait at an elevated level above the bottom surface. There is also a long-felt need in the art for a bottom bouncer device that protects wildlife by keeping lead-type bouncers out of the water. Further, there is a long-felt need in the art for a bottom bouncer device that allows the bait to be above weed beds. Moreover, there is a long-felt need in the art for a device that reduces lead pollution compared to current bottom bouncer devices in use. Further, there is a long-felt need in the art for a bottom bouncer device that features a weedless design to allow more fishing time for users. Finally, there is a long-felt need in the art for a bottom bouncer device that improves the overall health and fitness of users capable of light exercise.

The present invention, in one exemplary embodiment, is a novel bottom bouncer device which provides fishermen with lead-free bait at an elevated level above the bottom surface. The device comprises a round, brass rod with a split ring at the top and a snap swivel attached to the split ring. Thus, the device allows the bait to be above weed beds and reduces lead pollution. The present invention also includes a novel method of providing fishermen with lead-free bait at an elevated level above the bottom surface. The method includes the steps of providing fishermen with a bottom bouncer device. The method also comprises utilizing the device to position the bait at an elevated level above the bottom structure. Further, the method comprises reducing lead pollution by utilizing the lead-free bottom bouncer device. Finally, fishing with the bottom bouncer device without having the bait in the weed beds provides more fishing time.

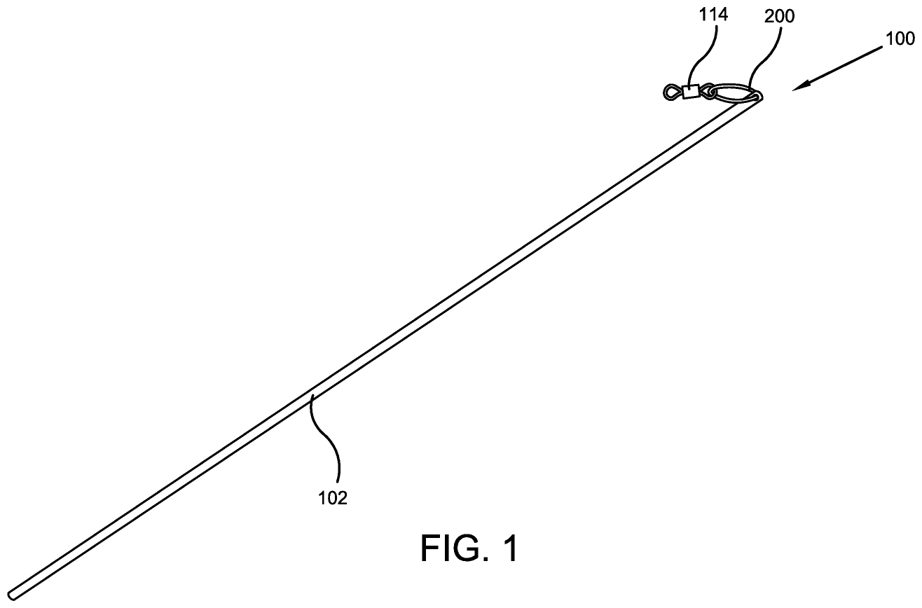

Referring initially to the drawings, FIG. 1 illustrates a perspective view of one embodiment of the bottom bouncer device 100 of the present invention. In the present embodiment, the bottom bouncer device 100 is an improved bottom bouncer device that is configured for a fishing rod and is both lead-free and weedless. The device 100 is especially designed to allow any fishermen, commercial or personal fishermen, etc., or any other suitable user as is known in the art, to easily bottom fish or troll. More specifically, the device 100 comprises a round rod 102. Typically, the device 100 comprises a round, brass rod 102, but the rod 102 can be made of any other suitable material as is known in the art, such as metallic material in the form of a length of a steel rod or wire selected from conventional stock materials, rust resistant spring steel, carbon fiber, polymer, etc. The round rod 102 typically comprises a diameter of from about 0.035 to about 0.190 inches, but can be any suitable diameter as is known in the art. Further, the round rod 102 is generally cylindrically shaped, but could also be hexagonally shaped, circular shaped, rectangular shaped, square shaped, or triangular shaped, etc., or any other suitable shape as is known in the art, depending on the needs and/or wants of a user.

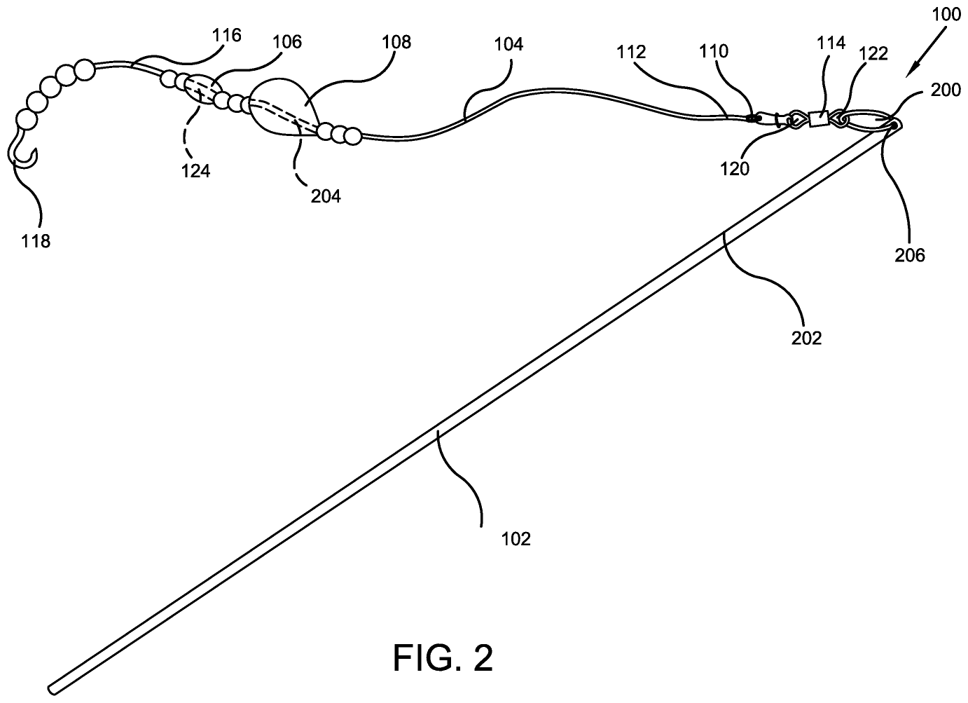

FIG. 2 illustrates a perspective view of another embodiment of the bottom bouncer device 100 of the present invention. In this embodiment the bottom bouncer device 100 comprises a flexible line 104, a float 106, and at least one weight 108. The flexible line 104 is fabricated from wire, cable or any other suitable material as is known in the art. A loop 110 is then formed on one end 112 of the flexible line 104 for attachment of a swivel connection, such as a snap swivel 114, or other suitable swivel connection as is known in the art. The snap swivel 114 is provided to facilitate attachment of a line or leader, and to prevent tangling of the line while in the water. The snap swivel 114 also prevents the float 106 and/or the weight 108 from moving past a certain point on the fishing (flexible) line 104. However, it is also within the scope of the invention to omit the snap swivel 114 entirely, or to substitute the snap swivel 114 with a lure or other device, without departing from the scope of the invention.

Typically, a leader line 116 with a hook 118, or a fishing line with a hook are then connected to the flexible line 104, or any other suitable line with a hook can be connected to the flexible line 104, as is known in the art. The leader line 116 with a hook 118 can also be attached directly to the snap swivel 114, instead of the flexible line 104. Further, a fishing line from a fishing rod and reel (not shown) can also be attached to the snap swivel 114 and/or the flexible line 104. Typically, the snap swivel 114 has a first eyelet 120 at a first upper end to which the leader line 116 and fishing line are connected. The first eyelet 120 is also where the loop 110, formed on the one end 112 of the flexible line 104, is attached. Additionally, the float 106 preferably includes a lengthwise through hole 124 for receiving the flexible line 104. Generally, the float 106 is fabricated from any suitable buoyant material. The float 106 is preferably retained on one end 112 of the flexible line 104 by securing the float 106 thereto. Typically, the float 106 is secured to the flexible line 104 via tying, spring hook, water resistant adhesive, etc., or any other suitable method as is known in the art.

In one embodiment, a split ring 200 is secured to the top 202 of the brass rod 102 via a through hole 206 in the rod 102 and a snap swivel 114 is then attached to the split ring 200 via a first or second eyelet 122 at a second lower end of the snap swivel 114. Then, a leader line 116 with a hook 118 or a fishing line with a hook are then connected to the snap swivel 114. The split ring 200 and snap swivel 114 combination allows for quick lure changes. Split rings 200 come in different weights, materials and sizes, depending on the needs and/or wants of a user. Further, users can swap-out their hook hangers with split rings 200 and can even swap-out fishing hooks as well, depending on the needs and/or wants of a user.

In another embodiment, the weight 108 includes a dense body. The dense body has a mass that is greater than the mass of water, such that the weight 108 sinks to a bottom of water. A lengthwise through hole 204 is formed through the dense body for receiving the flexible line 104. The removability of the weight 108 allows different masses of weights 108 to be quickly removed and secured to the flexible line 104. The weight 108 may also be used on a fishing line cast from a fishing rod and reel without the benefit of the bottom bouncer. However, any suitable type of fastenable weight 108 may be used, such as a split shot, etc. A split shot includes a split for retention of a flexible line 104. An outside perimeter of the split shot is squeezed and the flexible line 104 is retained in the split shot.

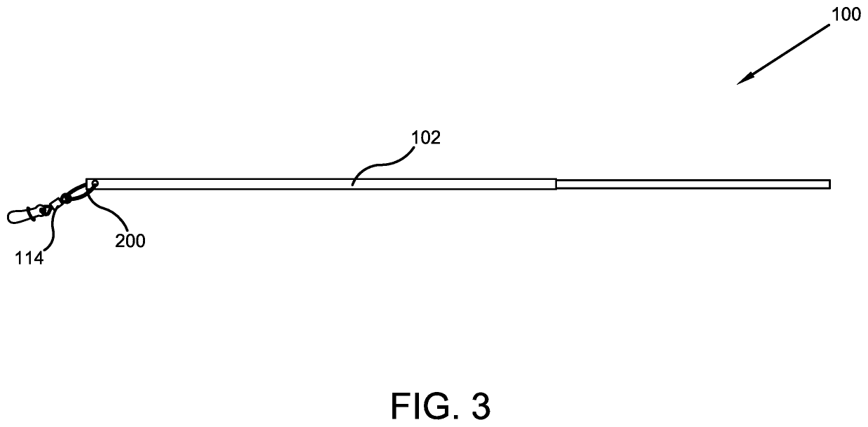

FIG. 3 illustrates a perspective view of another embodiment of the bottom bouncer device 100 of the present invention. In this embodiment, the bottom nine inches of the round rod 102 may be turned down in a lathe to produce differing weights for the bottom bouncer device 100. Thus, a user can utilize a lathe to set the round rod 102 to the desired weight. Keeping the round rod 102 weight high can also help users to avoid attaching any additional weights 108 on the fishing line 104. The bottom bouncer device 100 then provides fishermen with a lead-free bait at an elevated level above the bottom surface. Specifically, the device 100 allows the bait to be positioned above weed beds, rocks, sunken logs, and other snags.

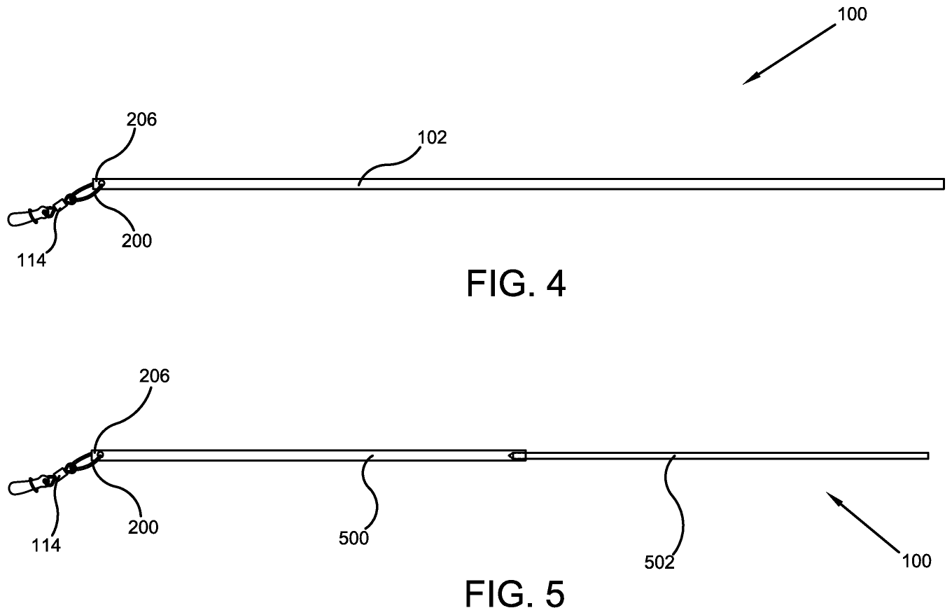

FIGS. 4-5 illustrate a perspective view of another embodiment of the bottom bouncer device 100 of the present invention. As shown in FIG. 4, the round rod 102 can be a single piece with a length of approximately 18.44 inches and a diameter of approximately 0.1875 inches. However, any suitable length or diameter can be utilized for the bottom bouncer device 100 as is known in the art, depending on the needs and/or wants of a user. In yet another embodiment, as shown in FIG. 5, the round rod 102 can be comprised of two rod components press fit together to form a single rod. In this embodiment, the first rod component 500 would have a diameter of approximately 0.1875 inches and the second rod component 502 would have a diameter of approximately 0.1563 inches, such that the second rod component 502 will fit inside the first rod component 500. Thus, the total length of the two rod components 500 and 502 secured together would be approximately 17.8516 inches. However, any suitable length or diameter can be utilized for the bottom bouncer device 100 as is known in the art, depending on the needs and/or wants of a user. Further, the two rod components 500 and 502 can be secured together via any suitable securing means, such as press fit, screwed, etc., depending on the needs and/or wants of a user.

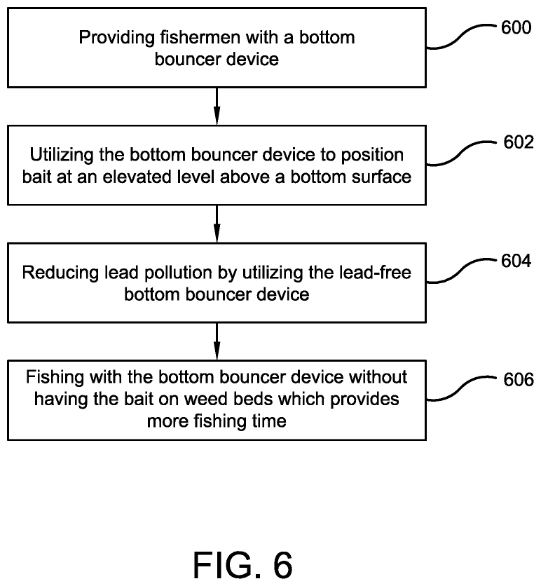

FIG. 6 illustrates a flowchart of the method of providing fishermen with lead-free bait at an elevated level above the bottom surface. The method includes the steps of at 600, providing fishermen with a bottom bouncer device, wherein the device comprises a round rod with a split ring at the top and a snap swivel attached to the split ring. The method also comprises at 602, utilizing the device to position the bait at an elevated level above the bottom structure. Further, the method comprises at 604, reducing lead pollution by utilizing the lead-free bottom bouncer device. Finally, at 606, fishing with the bottom bouncer device without having the bait in the weed beds, which provides more fishing time.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “bottom bouncer device” and “device” are interchangeable and refer to the bottom bouncer device 100 of the present invention.

Notwithstanding the forgoing, the bottom bouncer device 100 of the present invention can be of any suitable size and configuration as is known in the art without affecting the overall concept of the invention, provided that it accomplishes the above-stated objectives. One of ordinary skill in the art will appreciate that the bottom bouncer device 100 as shown in FIGS. 1-6 is for illustrative purposes only, and that many other sizes and shapes of the bottom bouncer device 100 are well within the scope of the present disclosure. Although the dimensions of the bottom bouncer device 100 are important design parameters for user convenience, the bottom bouncer device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A bottom bouncer device configured for a fishing rod and that is both lead-free and weedless, the bottom bouncer device comprising:
a rod;
a split ring secured to a top of the rod via a through hole in the rod; and
a snap swivel attached to the split ring;
wherein a first eyelet of the snap swivel connects to a flexible line and to the split ring, and further wherein the flexible line comprises at least one additional device.

2. The bottom bouncer device of claim 1, wherein the rod is a cylindrical, brass rod.

3. The bottom bouncer device of claim 2, wherein the at least one additional device is selected from a float and at least one weight.

4. The bottom bouncer device of claim 3, wherein each of the float and at least one weight is secured to the flexible line.

5. The bottom bouncer device of claim 4, wherein the float comprises a lengthwise through hole for receiving the flexible line.

6. The bottom bouncer device of claim 5, wherein a loop is formed at one end of the flexible line for attachment to the first eyelet of the snap swivel.

7. The bottom bouncer device of claim 1 wherein a leader line with a hook is connected to the snap swivel.

8. The bottom bouncer device of claim 7, wherein a first eyelet of the snap swivel connects to the leader line.

9. The bottom bouncer device of claim 1, wherein a bottom nine inches of the rod can be turned down with a lathe to produce differing weights.

10. The bottom bouncer device of claim 1, wherein the rod is a single piece.

11. The bottom bouncer device of claim 1, wherein the rod comprises a first rod component and a second rod component.

12. The bottom bouncer device of claim 11, wherein the second rod component is press fit into the first rod component.

13. A bottom bouncer device configured for a fishing rod and that is both lead-free and weedless, the bottom bouncer device comprising:
a rod having a top and a through hole;
a split ring secured to the top via the through hole; and
a snap swivel attached to the split ring; and
a first eyelet on the snap swivel connected to a flexible line and the split ring; and
a second eyelet on the snap swivel, wherein the flexible line comprises a float and at least one weight, and further wherein a loop is formed at one end of the flexible line for attachment to the first eyelet of the snap swivel.

14. The bottom bouncer device of claim 13, wherein the rod is a single piece.

15. The bottom bouncer device of claim 13, wherein the rod comprises a first and a second rod component.

16. The bottom bouncer device of claim 13, wherein a bottom nine inches of the rod can be turned down with a lathe to produce differing weights.

17. The bottom bouncer device of claim 13, wherein a leader line with a hook is connected to the snap swivel.

18. The bottom bouncer device of claim 17, wherein a first eyelet of the snap swivel connects to the leader line.

19. A method of enabling a fisherman to position a bait at an elevated level above a bottom surface of a body of water in a lead-free and weedless manner, the method comprising the steps of:
providing a bottom bouncer device that is lead-free;
utilizing the bottom bouncer device to position the bait at the elevated level above the bottom surface of the body of water;
preventing a lead pollution of the body of water by utilizing the lead-free bottom bouncer device; and
fishing with the bottom bouncer device without having the bait in weed beds which provides more fishing time.

20. The method of claim 19, wherein the bottom bouncer device comprises a round rod with a split ring at the top and a snap swivel attached to the split ring.
